(19) United States
(12) Patent Application Publication
(10) Pub. No.: US 2014/0205914 A1
(43) Pub. Date: Jul. 24, 2014

(54) ELECTROLYTE FOR LITHIUM RECHARGEABLE BATTERY AND LITHIUM RECHARGEABLE BATTERY INCLUDING THE ELECTROLYTE

(71) Applicant: SAMSUNG SDI CO., LTD., Yongin-si (KR)

(72) Inventors: SANG-IL HAN, Yongin-si (KR); Woo-Cheol SHIN, Yongin-si (KR); Jung-Yi YU, Yongin-si (KR); Tae-Hyun BAE, Yongin-si (KR); Myung-Hwan JEONG, Yongin-si (KR); Sang-Gun KIM, Yongin-si (KR)

(73) Assignee: SAMSUNG SDI CO., LTD., Yongin-si (KR)

(21) Appl. No.: 14/106,546

(22) Filed: Dec. 13, 2013

(30) Foreign Application Priority Data
Jan. 24, 2013 (KR) 10-2013-0008105

(51) Int. Cl. H01M 10/056; H01M 10/052

(52) U.S. Cl. CPC H01M 10/056; H01M 10/052
USPC 429/332; 429/188; 429/199; 429/200

(57) ABSTRACT

Disclosed are an electrolyte for a rechargeable lithium battery including an ionic liquid represented by Chemical Formula 1, a lithium salt, and an organic solvent, and a rechargeable lithium battery including the electrolyte for a rechargeable lithium battery.

### CROSS-REFERENCE TO RELATED APPLICATIONS

This application claims priority to and the benefit of Korean Patent Application No. 10-2013-0008105 filed in the Korean Intellectual Property Office on Jan. 24, 2013, the entire contents of which are incorporated herein by reference.

### BACKGROUND

1. Field

An electrolyte for a rechargeable lithium battery and a rechargeable lithium battery including the same are disclosed.

2. Description of the Related Technology

In general, batteries transform chemical energy generated from an electrochemical redox reaction of a chemical material in the battery into electrical energy. Such batteries are divided into a primary battery, which should be disposed after the energy of the battery is all consumed, and a rechargeable battery, which can be recharged many times.

The rechargeable battery can be charged/discharged many times based on the reversible transformation between chemical energy and electrical energy. Recent developments in high-tech electronics have allowed electronic devices to become small and light in weight, which leads to an increase in portable electronic devices.

As a power source for such portable electronic devices, the demands for batteries with high energy density are increasing and researches on lithium rechargeable battery are briskly under progress.

The rechargeable lithium battery is fabricated by an injecting electrolyte into an electrode assembly, which includes a positive electrode including a positive active material capable of intercalating/deintercalating lithium and a negative electrode including a negative active material capable of intercalating/deintercalating lithium. An electrolyte includes an organic solvent in which a lithium salt is dissolved and critically determines stability and performance of a rechargeable lithium battery.

### SUMMARY

One embodiment provides an electrolyte for a rechargeable lithium battery being capable of maintaining performance while securing stability.

Another embodiment provides a rechargeable lithium battery including the electrolyte.

According to one embodiment, an electrolyte for a rechargeable lithium battery including an ionic liquid represented by the following Chemical Formula 1, a lithium salt, and an organic solvent is provided:

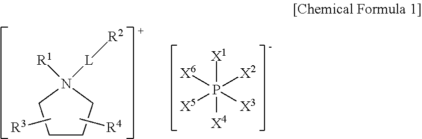

In Chemical Formula 1,

R¹ is hydrogen, a substituted or unsubstituted C₁ to C₃₀ alkyl group, a substituted or unsubstituted C₃ to C₃₀ cycloalkyl group, a substituted or unsubstituted C6 to C30 an aryl group, a substituted or unsubstituted C₁ to C₂₀ heteroalkyl group, a substituted or unsubstituted C₂ to C₃₀ heterocycloalkyl group, a substituted or unsubstituted C₂ to C₃₀ heteroaryl group, or a combination thereof,

R² is a substituted or unsubstituted C₁ to C₃₀ alkoxy group,

R³ and R⁴ are each independently hydrogen, a substituted or unsubstituted C₁ to C₃₀ alkyl group, a substituted or unsubstituted C₃ to C₃₀ cycloalkyl group, a substituted or unsubstituted C₆ to C₃₀ an aryl group, a substituted or unsubstituted C₁ to C₂₀ heteroalkyl group, a substituted or unsubstituted C₂ to C3₀ heterocycloalkyl group, a substituted or unsubstituted C₂ to C₃₀ heteroaryl group, or a combination thereof,

L is a single bond or a substituted or unsubstituted C₁ to C₂₀ alkylene group,

X¹ to X⁶ are each independently halogen, a C₁ to C₂₀ alkyl group substituted with at least one halogen, a C₁ to C₂₀ cycloalkyl group substituted with at least one halogen, a C₁ to C₂₀ aryl group substituted with at least one halogen, or a combination thereof, and

at least two of X¹ to X⁶ are each independently a C₁ to C₂₀ alkyl group substituted with at least one halogen, a C₁ to C₂₀ cycloalkyl group substituted with at least one halogen, a C₁ to C₂₀ aryl group substituted with at least one halogen, or a combination thereof.

The ionic liquid may be represented by the following Chemical Formula 2.

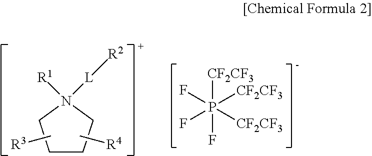

In Chemical Formula 2,

R¹ is hydrogen, a substituted or unsubstituted C₁ to C₃₀ alkyl group, a substituted or unsubstituted C₃ to C₃₀ cycloalkyl group, a substituted or unsubstituted C₆ to C₃₀ an aryl group, a substituted or unsubstituted C₁ to C₂₀ heteroalkyl group, a substituted or unsubstituted C₂ to C₃₀ heterocycloalkyl group, a substituted or unsubstituted C₂ to C₃₀ heteroaryl group, or a combination thereof,

R² is a substituted or unsubstituted C₁ to C₃₀ alkoxy group,

R³ and R⁴ are each independently hydrogen, a substituted or unsubstituted C₁ to C₃₀ alkyl group, a substituted or unsubstituted C₃ to C₃₀ cycloalkyl group, a substituted or unsubstituted C₆ to C₃₀ an aryl group, a substituted or unsubstituted C₁ to C₂₀ heteroalkyl group, a substituted or unsubstituted C₂ to C₃₀ heterocycloalkyl group, a substituted or unsubstituted C₂ to C₃₀ heteroaryl group, or a combination thereof, and

L is a single bond or a substituted or unsubstituted C₁ to C₂₀ alkylene group.

The ionic liquid may be represented by the following Chemical Formula 3.

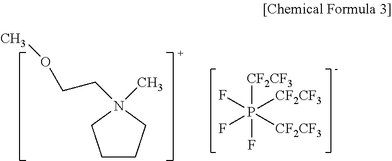

The ionic liquid may be included in an amount of about 1 volume % to about 50 volume % based on the total amount of the electrolyte.

The ionic liquid may be included in an amount of about 5 volume % to 40 volume % based on the total amount of the electrolyte.

The electrolyte may further include a fluorine-substituted carbonate-based compound.

The fluorine-substituted carbonate-based compound may include fluoroethylene carbonate (FEC).

The fluorine-substituted carbonate-based compound may be included in an amount of about 1 wt % to about 40 wt % based on the total amount of the electrolyte.

The organic solvent may include ethylene carbonate (EC)/ethylmethyl carbonate (EMC)/dimethyl carbonate (DMC).

The electrolyte may have a viscosity of less than or equal to about 100 cP.

The electrolyte may have a viscosity of about 3 cP to about 100 cP.

The electrolyte may have a viscosity of about 3 cP to about 15 cP.

The electrolyte may have ionic conductivity of about 1.0×10⁻³ S/cm to about 9.9×10⁻³ S/cm.

According to another embodiment, a rechargeable lithium battery including a positive electrode including a positive active material, a negative electrode including a negative active material, and the electrolyte is provided.

The rechargeable lithium battery may further include a passivation film on a surface of the negative electrode, and the passivation film may be formed from the electrolyte.

The electrolyte ensures battery stability due to improved flame retardancy and prevents deterioration of battery performance by adjusting viscosity of an electrolyte.

### BRIEF DESCRIPTION OF THE DRAWING

FIG. 1 is a schematic view showing a rechargeable lithium battery according to one embodiment.

### DETAILED DESCRIPTION

This disclosure will be described more fully hereinafter, in which example embodiments are shown. As those skilled in the art would realize, the described embodiments may be modified in various different ways, all without departing from the spirit or scope of the present embodiments.

As used herein, when a definition is not otherwise provided, the term ‘substituted’ may refer to one substituted with a substitutent selected from halogen (F, Br, Cl, or I), a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid or a salt thereof, a C₁ to C₂₀ alkyl group, a C₂ to C₂₀ alkenyl group, a C₂ to C₂₀ alkynyl group, a C₆ to C₃₀ an aryl group, a C₇ to C₃₀ arylalkyl group, a C₁ to C₂₀ alkoxy group, a C₁ to C₂₀ heteroalkyl group, a C₃ to C₂₀ heteroarylalkyl group, a C₃ to C₃₀ cycloalkyl group, a C₃ to C₁₅ cycloalkenyl group, a C₆ to C₁₅ cycloalkynyl group, a C₂ to C₂₀ heterocycloalkyl group, and a combination thereof, instead of hydrogen of a compound.

As used herein, when a definition is not otherwise provided, the term ‘hetero’ may refer to one including 1 to 3 heteroatoms selected from, N, O, S, and P.

Hereinafter, an electrolyte for a rechargeable lithium battery according to one embodiment is described.

The electrolyte for a rechargeable lithium battery according to one embodiment includes an ionic liquid represented by the following Chemical Formula 1, a lithium salt, and an organic solvent.

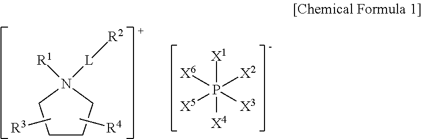

In Chemical Formula 1,

R¹ is hydrogen, a substituted or unsubstituted C₁ to C₃₀ alkyl group, a substituted or unsubstituted C₃ to C₃₀ cycloalkyl group, a substituted or unsubstituted C₆ to C₃₀ an aryl group, a substituted or unsubstituted C₁ to C₂₀ heteroalkyl group, a substituted or unsubstituted C₂ to C₃₀ heterocycloalkyl group, a substituted or unsubstituted C₂ to C₃₀ heteroaryl group, or a combination thereof,

R² is a substituted or unsubstituted C₁ to C₃₀ alkoxy group,

R³ and R⁴ are each independently hydrogen, a substituted or unsubstituted C₁ to C₃₀ alkyl group, a substituted or unsubstituted C₃ to C₃₀ cycloalkyl group, a substituted or unsubstituted C₆ to C₃₀ an aryl group, a substituted or unsubstituted C₁ to C₂₀ heteroalkyl group, a substituted or unsubstituted C₂ to C₃₀ heterocycloalkyl group, a substituted or unsubstituted C₂ to C₃₀ heteroaryl group, or a combination thereof,

L is a single bond or a substituted or unsubstituted C₁ to C₂₀ alkylene group,

X¹ to X⁶ are each independently halogen, a C₁ to C₂₀ alkyl group substituted with at least one halogen, a C₁ to C₂₀ cycloalkyl group substituted with at least one halogen, a C₁ to C₂₀ aryl group substituted with at least one halogen, or a combination thereof, and

at least two of X¹ to X⁶ are each independently a C₁ to C₂₀ alkyl group substituted with at least one halogen, a C₁ to C₂₀ cycloalkyl group substituted with at least one halogen, a C₁ to C₂₀ aryl group substituted with at least one halogen, or a combination thereof.

The compound represented by Chemical Formula 1 is an ionic liquid including a cation and an anion, and a salt showing liquid characteristic at room temperature.

In general, the ionic liquid is included in an electrolyte and thus, may improve flame retardancy. However, when the ionic liquid is excessively included to improve flame retardancy, the electrolyte including the same may have higher viscosity and have an influence on performance and cycle-life of a rechargeable lithium battery.

According to the embodiment, the electrolyte includes a compound represented by Chemical Formula 1 as the ionic liquid to prevent viscosity increase as well as improve flame retardancy.

Specifically, the compound represented by Chemical Formula 1 includes a cation including pyrrolidinium substituted with an alkoxy-containing group and a bulky anion.

The pyrrolidinium substituted with the alkoxy-containing group may form a passivation film on an electrode due to decomposition of the alkoxy group. The passivation film may lower exothermic characteristic and improve flame retardancy and simultaneously, improve performance of a rechargeable lithium battery.

The anion has a bulky moiety, for example, a hydrocarbon moiety substituted with a halogen for at least two out of X¹ to X⁶ and thus, may prevent viscosity increase of the electrolyte.

Accordingly, the compound represented by Chemical Formula 1 improves flame retardancy of an electrolyte and increase stability of a rechargeable lithium battery and simultaneously, appropriately maintains viscosity of the electrolyte and thus, prevent performance and cycle-life characteristic deterioration of the rechargeable lithium battery.

The ionic liquid may be for example a compound represented by the following Chemical Formula 2.

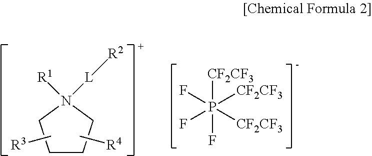

In Chemical Formula 2, R¹ to R⁴ and L are the same as described above.

The ionic liquid may be for example a compound represented by the following Chemical Formula 3.

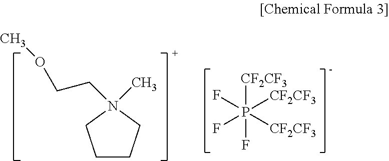

The ionic liquid may be included in an amount of about 1 volume % to about 50 volume % based on the total amount of the electrolyte. When the ionic liquid is included within the range, the electrolyte may maintain appropriate viscosity and have higher flame retardancy. The ionic liquid may be included in an amount of about 5 volume % to about 40 volume % within the range.

The organic solvent plays a role of transmitting ions taking part in the electrochemical reaction of a battery.

The organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and the like. The carbonate-based solvent may be, for example a mixed solvent of ethylene carbonate (EC)/ethylmethyl carbonate (EMC)/dimethyl carbonate (DMC) at a predetermined ratio.

The ester-based solvent may include methyl acetate, ethyl acetate, n-propyl acetate, dimethylacetate, methylpropinonate, ethylpropinonate, gamma-butyrolactone, decanolide, gamma-valerolactone, mevalonolactone, caprolactone, and the like.

The ether-based solvent may include dibutyl ether, tetraglyme, diglyme, dimethoxyethane, 2-methyltetrahydrofuran, tetrahydrofuran and the like, and the ketone-based solvent may include cyclohexanone, and the like. The alcohol-based solvent may include ethanol, isopropyl alcohol, and the like. The aprotic solvent include nitriles such as R—CN (wherein R is a C₂ to C₂₀ linear, branched, or cyclic hydrocarbon group, and may include a double bond, an aromatic ring, or an ether bond), amides such as dimethylformamide, dimethylacetamide, dioxolanes such as 1,3-dioxolane, sulfolanes, and the like.

The organic solvent may be used singularly or in a mixture. When the organic solvent is used in a mixture, its mixture ratio may be controlled in accordance with desirable performance of a battery.

The carbonate-based solvent may include a mixture of a cyclic carbonate and a linear carbonate. The cyclic carbonate and the linear carbonate are mixed together in a volume ratio of about 1:1 to about 1:9, which may enhance performance of an electrolyte.

In addition, the organic solvent may be prepared by further adding the aromatic hydrocarbon-based organic solvent to the carbonate-based solvent. The carbonate-based solvent and the aromatic hydrocarbon-based organic solvent are mixed together in a volume ratio of about 1:1 to about 30:1.

The aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The lithium salt is dissolved in the organic solvent and supplies lithium ions in a rechargeable lithium battery, and basically operates the rechargeable lithium battery and improves lithium ion transfer between positive and negative electrodes. Such a lithium salt includes one or more of LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₋₁SO₂)(C_{y}F_{2y+1}SO₂) (wherein, x and y are natural numbers), LiCl, and LiI.

The lithium salt may be used at a concentration of about 0.1 to about 2.0M. When the lithium salt is included within the above concentration range, it may electrolyte performance and lithium ion mobility due to optimal electrolyte conductivity and viscosity.

The electrolyte may further include an additive. The additive may be, for example a fluorine-substituted carbonate-based compound, and for example fluoroethylene carbonate (FEC).

The fluorine-substituted carbonate-based compound may be included in an amount of about 1 wt % to about 40 wt % based on the total amount of the electrolyte. When the fluorine-substituted carbonate-based compound is included within the range, a passivation film may be formed to have an appropriate thickness on the surface of an electrode and prevent sharp viscosity increase of the electrolyte.

The electrolyte may have, for example a viscosity of less than or equal to about 100 cP, and specifically about 3 cP to about 100 cP. When the electrolyte has viscosity within the range, the electrolyte may not deteriorate cycle characteristic of a rechargeable lithium battery and improve cycle-life characteristic thereof. The electrolyte may have viscosity of about 3 cP to about 15 cP within the range.

The electrolyte may have, for example ionic conductivity of about 1.0×10⁻³ S/cm to about 9.9×10⁻³ S/cm. When the electrolyte has ionic conductivity within the range, the electrolyte may improve battery performance.

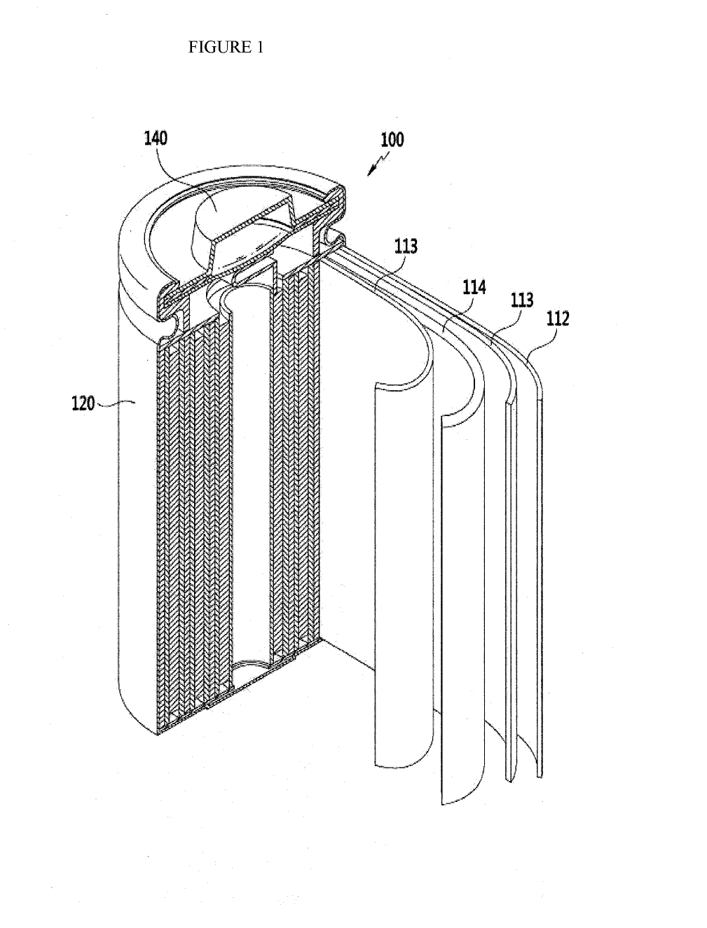

Hereinafter, a rechargeable lithium battery according to another embodiment is described referring to FIG. 1.

FIG. 1 is a schematic view of a rechargeable lithium battery according to one embodiment.

Referring to FIG. 1, a rechargeable lithium battery 100 according to one embodiment includes a battery cell including a positive electrode 114, a negative electrode 112 facing the positive electrode 114, a separator 113 interposed between the positive electrode 114 and negative electrode 112, and an electrolyte (not shown) for a rechargeable lithium battery impregnating the positive electrode 114, negative electrode 112, and separator 113, a battery case 120 including the battery cell, and a sealing member 140 sealing the battery case 120.

The rechargeable lithium battery 100 is fabricated by sequentially laminating a negative electrode 112, a positive electrode 114, and a separator 113, spirally winding them, and housing the spiral-wound product in a battery case 120.

The negative electrode 112 may a current collector and a negative active material layer disposed on at least one side of the current collector.

The current collector may include a copper foil, a nickel foil, a stainless steel foil, a titanium foil, a nickel foam, a copper foam, a polymer substrate coated with a conductive metal, or a combination thereof.

The negative active material layer includes a binder and optionally, a conductive material.

The negative active material may include a material that reversibly intercalates/deintercalates lithium ions, a lithium metal, a lithium metal alloy, a material being capable of doping and dedoping lithium, or transition metal oxide.

The material that reversibly intercalates/deintercalates lithium ions includes a carbon material. The carbon material may be any generally-used carbon-based negative active material in a lithium ion rechargeable battery. Examples of the carbon material include crystalline carbon, amorphous carbon, and a mixture thereof. The crystalline carbon may be non-shaped or sheet, flake, spherical, or fiber shaped natural graphite or artificial graphite. The amorphous carbon may be a soft carbon, a hard carbon, mesophase pitch carbonization products, fired coke, and the like.

Examples of the lithium metal alloy include lithium and a metal of Na, K, Rb, Cs, Fr, Be, Mg, Ca, Sr, Si, Sb, Pb, In, Zn, Ba, Ra, Ge, Al, or Sn.

The material being capable of doping and dedoping lithium may include Si, SiOₓ (0<x<2), a Si-Q composite, a Si-Q alloy (wherein Q is an alkali metal, an alkaline-earth metal, Group 13 to Group 16 elements, a transition element, a rare earth element, or a combination thereof, and is not Si), Sn, SnO₂, a Sn—C composite, a Sn—R alloy (wherein R is an alkali metal, an alkaline-earth metal, Group 13 to Group 16 elements, a transition element, a rare earth element, or a combination thereof, and not Sn), and the like. The elements Q and R may include, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The transition metal oxide may include vanadium oxide, lithium vanadium oxide, and the like.

The binder improves properties of binding active material particles with one another and a negative active material with a current collector. Examples of the binder include polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves electrical conductivity of a negative electrode. Any electrically conductive material can be used as a conductive agent, unless it causes a chemical change. Examples of the conductive material include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative, and the like; or a mixture thereof.

The positive electrode 114 includes a current collector and a positive active material layer disposed on the current collector.

The current collector may be an Al, but is not limited thereto.

The positive active material layer includes a positive active material, a binder, and optionally a conductive material.

The positive active material includes lithiated intercalation compounds that reversibly intercalate and deintercalate lithium ions. The positive active material may include a composite oxide including at least one selected from the group consisting of cobalt, manganese, and nickel, as well as lithium. Specific examples may be the compounds represented by the following chemical formulae:

LiₐA_{1-b}RbD₂ (0.90≦a≦1.8 and 0≦b≦0.5); LiₐE_{1-b}R_{b}O_{2-c}D_{c} (0.90≦a≦1.8, 0≦b≦0.5 and 0≦c≦0.05); LiE_{2-b}R_{b}O_{4-c}D_{c} (0≦b≦0.5, 0≦c≦0.05); LiₐNi_{1-b-c}Co_{b}R_{c}D_{α} (0.90≦a≦1.8, 0≦b≦0.5, 0≦c≦0.05 and 0≦a≦2); LiₐNi_{1-b-c}Co_{b}R_{c}O_{2-α}Z_{α} (0.90≦a≦1.8, 0≦b≦0.5, 0≦c≦0.05 and 0≦a≦2); LiₐNi_{1-b-c}Co_{b}R_{c}O_{2-α}Z₂ (0.90≦a≦1.8, 0≦b≦0.5, 0≦c≦0.05 and 0<α<2); LiₐNi_{1-b-c}Mn_{b}R_{c}D_{α} (0.90≦a≦1.8, 0≦b≦0.5, 0≦c≦0.05 and 0≦α≦2); LiₐNi_{1-b-c}Mn_{b}R_{c}O_{2-α}Z_{α} (0.90≦a≦1.8, 0≦b≦0.5, 0≦c≦0.05 and 0<α<2); LiₐNi_{1-b-c}Mn_{b}R_{c}O_{2-α}Z₂ (0.90≦a≦1.8, 0≦b≦0.5, 0≦c≦0.05 and 0<α<2); LiₐNi_{b}E_{c}G_{d}O₂ (0.90≦a≦1.8, 0≦b≦0.9, 0≦c≦0.5 and 0.001≦d≦0.1.); LiₐNi_{b}CoₑMn_{d}GₑO₂ (0.90≦a≦1.8, 0≦b≦0.9, 0≦c≦0.5, 0≦d≦0.5 and 0.001≦e≦0.1.); LiₐNiG_{b}O₂ (0.90≦a≦1.8 and 0.001≦b≦0.1.); LiₐCoG_{b}O₂ (0.90≦a≦1.8 and 0.001≦b≦0.1.); LiₐMnG_{b}O₂ (0.90≦a≦1.8 and 0.001≦b≦0.1.); LiₐMn₂G_{b}O₄ (0.90≦a≦1.8 and 0.001≦b≦0.1.); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; J is V, Cr, Mn, Co, Ni, Cu, or a combination thereof.

The positive active material may be a compound with the coating layer on the surface or a mixture of the active material and a compound with the coating layer thereon. The coating layer may include at least one coating element compound selected from the group consisting of an oxide of the coating element, a hydroxide of the coating element, an oxyhydroxide of the coating element, an oxycarbonate of the coating element, and a hydroxycarbonate of the coating element. The compound for the coating layer may be either amorphous or crystalline. The coating element included in the coating layer may be Mg, Al, Co, K, Na, Ca, Si, Ti, V, Sn, Ge, Ga, B, As, Zr, or a mixture thereof. The coating process may include any conventional processes unless it causes any side effects on the properties of the positive active material (e.g., spray coating, immersing), which is well known to those who have ordinary skill in this art and will not be illustrated in detail.

The binder improves binding properties of the positive active material particles to one another and to a current collector. Examples of the binder includepolyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but is not limited thereto.

The conductive material improves electrical conductivity of a negative electrode. Any electrically conductive material can be used as a conductive agent unless it causes a chemical change. Examples of the conductive material include natural graphite, artificial graphite, carbon black, acetylene black, ketjen black, a carbon fiber, a metal powder or a metal fiber including copper, nickel, aluminum, silver, and the like. A conductive material such as a polyphenylene derivative and the like may be mixed.

The negative and positive electrodes may be manufactured in a method of preparing an active material composition by mixing the active material and a binder, and optionally a conductive material, and coating the active material composition on a current collector. The solvent includes N-methylpyrrolidone and the like but is not limited thereto. The electrode manufacturing method is well known and thus, is not described in detail in the present specification.

The separator 113 separates the positive electrode 114 and negative electrode 112 and provides a path for transferring lithium ions. The separator 113 may be any separator that is generally used in a lithium ion battery. The separator may have low resistance against electrolyte ions and excellent moisturizing capability of an electrolyte. For example, the separator may be selected from a glass fiber, polyester, TEFLON (tetrafluoroethylne), polyethylene, polypropylene, polytetrafluoroethylene (PTFE), or a combination thereof and may have a non-woven fabric type or a fabric type. For example, a polyolefin-based polymer separator such as polyethylene, polypropylene, and the like is used for a lithium ion battery, a separator coated with a ceramic component or a polymer material may be used to secure heat resistance or mechanical strength. The separator may have a singular layer or multi-layers.

The rechargeable lithium battery may be classified as a lithium ion battery, a lithium ion polymer battery, and a lithium polymer battery according to the presence of a separator and the kind of an electrolyte used therein. The rechargeable lithium battery may have a variety of shapes and sizes and thus, may include a cylindrical, prismatic, coin, or pouch-type battery and a thin film type or a bulky type in size. The structure and manufacturing method for a lithium ion battery pertaining to the present embodiments are well known in the art.

The electrolyte is the same as described above.

The following examples illustrate the aspects of the present embodiments described above, in more detail. These examples, however, should not in any sense be interpreted as limiting the scope of the present embodiments.

### Preparation of Electrolyte

### Example 1

An electrolyte for a rechargeable lithium battery was prepared by adding 1.3M LiPF₆ of a lithium salt to a mixed solvent prepared by mixing ethylene carbonate (EC), ethylmethylcarbonate (EMC), and dimethylcarbonate (DMC) in a ratio of 3/4/3 (v/v/v) and 20 volume % of an ionic liquid represented by the following Chemical Formula 3 to 80 volume % of the mixture.

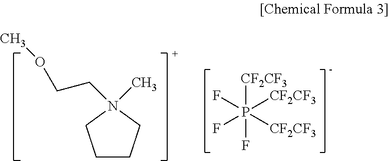

### Example 2

An electrolyte for a rechargeable lithium battery was prepared according to the same method as Example 1 except for further adding 5 wt % of fluoroethylenecarbonate (FEC) thereto.

### Comparative Example 1

An electrolyte for a rechargeable lithium battery was prepared according to the same method as Example 1 except for including no fluoroethylenecarbonate (FEC).

### Comparative Example 2

An electrolyte for a rechargeable lithium battery was prepared according to the same method as Example 1 except for using an ionic liquid represented by the following Chemical Formula A instead of the ionic liquid represented by the above Chemical Formula 3.

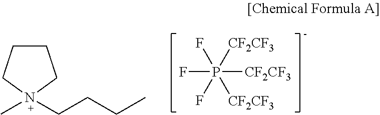

### Evaluation 1: Flame Retardancy

The electrolytes according to Examples 1 and 2 and Comparative Example 1 were evaluated regarding flame retardancy.

The flame retardancy was evaluated by respectively impregnating a glass fiber filter in the electrolytes (1 cm×1 cm) according to Examples 1 and 2 and Comparative Example 1 for 30 seconds, setting a fire on the glass fiber filter for 2 to 4 seconds, and measuring the burning time. The measured time is expressed by self-extinguishing time (SET) and marked as time per unit weight (sec/g).

The results are provided in Table 1.

TABLE 1

| | SET (sec/g) |
|---|---|
| Example 1 | 25 |
| Example 2 | 14 |
| Comparative Example 1 | 60 |

Referring to Table 1, the electrolytes according to Examples 1 and 2 had a shorter combustion time than the one according to Comparative Example 1. Accordingly, the electrolytes according to Examples 1 and 2 had excellent flame retardancy compared with the one according to Comparative Example 1.

### Evaluation 2: Viscosity

The electrolytes according to Examples 1 and 2 and Comparative Example 2 were evaluated regarding viscosity.

The viscosity was evaluated using a Brookfield viscometer (LVDV-II+PCP, Brookfield Engineering Laboratories).

The results are provided in Table 2.

TABLE 2

| | Viscosity (cP) |
|---|---|
| Example 1 | 8.4 |
| Example 2 | 10.2 |
| Comparative Example 2 | 18.0 |

Referring to Table 2, the electrolytes according to Examples 1 and 2 had lower viscosity than the one according to Comparative Example 2.

### Evaluation 3: Ionic Conductivity

The electrolytes according to Examples 1 and 2 and Comparative Examples 1 and 2 were evaluated regarding ionic conductivity.

The ionic conductivity was measured using a Mettler Toledo S30 SevenEasy Conductivity equipment.

The results are provided in Table 3.

TABLE 3

| | Ionic conductivity (S/cm) |
|---|---|
| Example 1 | 5.2 × 10⁻³ |
| Example 2 | 3.9 × 10⁻³ |
| Comparative Example 2 | 1.1 × 10⁻⁴ |

Referring to Table 3, the electrolytes according to Examples 1 and 2 had improved ionic conductivity compared with the one according to Comparative Example 2.

### Evaluation 4: Charge and Discharge Characteristics

Each electrolyte according to Examples 1 and 2 and Comparative Examples 1 and 2 was respectively used to fabricate a rechargeable lithium battery cell. Herein, a positive electrode was fabricated by using 92 wt % of LiNi_{0.5}Co_{0.2}Mn_{0.3}O₂, 4 wt % of denka black, and 4 wt % of polyvinylidene fluoride (PVdF, Solef6020), and artificial graphite (ICG 10H) was used as a negative electrode.

Each rechargeable lithium battery cell respectively including the electrolytes according to Examples 1 and 2 and Comparative Examples 1 and 2 were evaluated regarding charge and discharge characteristics.

The rechargeable lithium battery cells were charged and discharged with a charge potential of 0.1 C and 0.1V (0.02 C cut-off) and a discharge potential of 0.1 C and 1.0V at the first cycle, a charge potential of 0.2 C and 0.1V (0.05 C cut-off) and a discharge potential of 0.2 C and 1.0V at the second cycle, a charge potential of 0.5 C and 0.1V (0.05 C cut-off) and a discharge potential of 0.5 C and 1.0V at the third cycle, a charge potential of 1 C and 0.1V (0.05 C cut-off) and a discharge potential of 1 C and 1.0V at the fourth cycle, and a charge potential of 2 C and 0.1V (0.05 C cut-off) and 2 C and 1.0V of a discharge potential at the fifth cycle.

Table 4 shows discharge capacity, charge capacity, and irreversible efficiency of charge and discharge capacities.

TABLE 4

| | 0.5 C charge and | | 2 C charge and | | |
|---|---|---|---|---|---|
| | discharge capacity | | discharge capacity | | |
| | (mAh/g) | | (mAh/g) | | ICE (%) |
| | Charge | Discharge | Charge | Discharge | (Initial |
| | capacity | capacity | capacity | capacity | Columbic |
| | (@0.5 C) | (@0.5 C) | (@2 C) | (@2 C) | Efficiency) |
| Example 1 | 327 | 331 | 159 | 248 | 90.3 |
| Example 2 | 347 | 350 | 263 | 337 | 93.9 |
| Comparative | 344 | 345 | 302 | 330 | 95.2 |
| Example 1 | | | | | |
| Comparative | 280 | 285 | N/A | N/A | 85.0 |
| Example 2 | | | | | |

Referring to Table 4, the rechargeable lithium battery cells respectively including the electrolytes according to Examples 1 and 2 had similar capacity characteristic to that of the rechargeable lithium battery cell including the electrolyte according to Comparative Example 1 and improved capacity characteristic compared with the rechargeable lithium battery cell including the electrolyte according to Comparative Example 2.

Based on the results of Tables 1 to 4, the electrolytes according to Examples 1 and 2 had improved flame retardancy of the rechargeable lithium battery cells and simultaneously, characteristics thereof compared with the electrolytes according to Comparative Examples 1 and 2.

While these embodiments have been described in connection with what is presently considered to be practical example embodiments, it is to be understood that the present embodiments are not limited to the disclosed embodiments, but, on the contrary, is intended to cover various modifications and equivalent arrangements included within the spirit and scope of the appended claims.

What is claimed is:

1. An electrolyte for a rechargeable lithium battery, comprising
an ionic liquid represented by the following Chemical Formula 1, 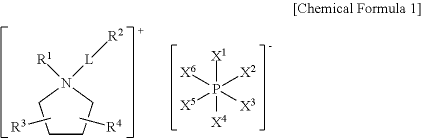
a lithium salt, and
an organic solvent:
wherein,
R¹ is hydrogen, a substituted or unsubstituted C₁ to C₃₀ alkyl group, a substituted or unsubstituted C₃ to C₃₀ cycloalkyl group, a substituted or unsubstituted C₆ to C₃₀ aryl group, a substituted or unsubstituted C₁ to C₂₀ heteroalkyl group, a substituted or unsubstituted C₂ to C₃₀ heterocycloalkyl group, a substituted or unsubstituted C₂ to C₃₀ heteroaryl group, or a combination thereof,
R² is a substituted or unsubstituted C₁ to C₃₀ alkoxy group,
R³ and R⁴ are each independently hydrogen, a substituted or unsubstituted C₁ to C₃₀ alkyl group, a substituted or unsubstituted C₃ to C₃₀ cycloalkyl group, a substituted or unsubstituted C₆ to C₃₀ aryl group, a substituted or unsubstituted C₁ to C₂₀ heteroalkyl group, a substituted or unsubstituted C₂ to C₃₀ heterocycloalkyl group, a substituted or unsubstituted C₂ to C₃₀ heteroaryl group, or a combination thereof,
L is a single bond or a substituted or unsubstituted C₁ to C₂₀ alkylene group,
X¹ to X⁶ are each independently halogen, a C₁ to C₂₀ alkyl group substituted with at least one halogen, a C₁ to C₂₀ cycloalkyl group substituted with at least one halogen, a C₁ to C₂₀ aryl group substituted with at least one halogen, or a combination thereof, and
at least two of X¹ to X⁶ are each independently a C₁ to C₂₀ alkyl group substituted with at least one halogen, a C₁ to C₂₀ cycloalkyl group substituted with at least one halogen, a C₁ to C₂₀ aryl group substituted with at least one halogen, or a combination thereof.

2. The electrolyte for a rechargeable lithium battery of claim 1, wherein the ionic liquid is represented by the following Chemical Formula 2: 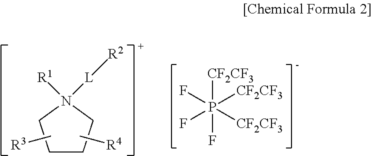
wherein,
R¹ is hydrogen, a substituted or unsubstituted C₁ to C₃₀ alkyl group, a substituted or unsubstituted C₃ to C₃₀ cycloalkyl group, a substituted or unsubstituted C₆ to C₃₀ an aryl group, a substituted or unsubstituted C₁ to C₂₀ heteroalkyl group, a substituted or unsubstituted C₂ to C₃₀ heterocycloalkyl group, a substituted or unsubstituted C₂ to C₃₀ heteroaryl group, or a combination thereof,
R² is a substituted or unsubstituted C₁ to C₃₀ alkoxy group,
R³ and R⁴ are each independently hydrogen, a substituted or unsubstituted C₁ to C₃₀ alkyl group, a substituted or unsubstituted C₃ to C₃₀ cycloalkyl group, a substituted or unsubstituted C₆ to C₃₀ an aryl group, a substituted or unsubstituted C₁ to C₂₀ heteroalkyl group, a substituted or unsubstituted C₂ to C₃₀ heterocycloalkyl group, a substituted or unsubstituted C₂ to C₃₀ heteroaryl group, or a combination thereof, and
L is a single bond or a substituted or unsubstituted C₁ to C₂₀ alkylene group.

3. The electrolyte for a rechargeable lithium battery of claim 2, wherein the ionic liquid is represented by the following Chemical Formula 3:

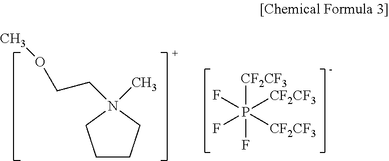

4. The electrolyte for a rechargeable lithium battery of claim 1, wherein the ionic liquid is included in an amount of about 1 volume % to about 50 volume % based on the total amount of the electrolyte.

5. The electrolyte for a rechargeable lithium battery of claim 1, wherein the ionic liquid is included in an amount of about 5 volume % to about 40 volume % based on the total amount of the electrolyte.

6. The electrolyte for a rechargeable lithium battery of claim 1, wherein the electrolyte further comprises a fluorine-substituted carbonate-based compound.

7. The electrolyte for a rechargeable lithium battery of claim 6, wherein the fluorine-substituted carbonate-based compound comprises fluoroethylene carbonate (FEC).

8. The electrolyte for a rechargeable lithium battery of claim 6, wherein the fluorine-substituted carbonate-based compound is included in an amount of about 1 wt % to about 40 wt % based on the total amount of the electrolyte.

9. The electrolyte for a rechargeable lithium battery of claim 1, wherein: the organic solvent comprises ethylene carbonate, ethylmethyl carbonate and dimethyl carbonate.

10. The electrolyte for a rechargeable lithium battery of claim 1, wherein the electrolyte has a viscosity of less than or equal to about 100 cP.

11. The electrolyte for a rechargeable lithium battery of claim 1, wherein the electrolyte has a viscosity of about 3 cP to about 100 cP.

12. The electrolyte for a rechargeable lithium battery of claim 1, wherein the electrolyte has a viscosity of about 3 cP to about 15 cP.

13. The electrolyte for a rechargeable lithium battery of claim 1, wherein the electrolyte has ionic conductivity of about 1.0×10⁻³ S/cm to about 9.9×10⁻³ S/cm.

14. A rechargeable lithium battery, comprising
a positive electrode including a positive active material,
a negative electrode including a negative active material, and
an electrolyte comprising an ionic liquid represented by the following Chemical Formula 1, 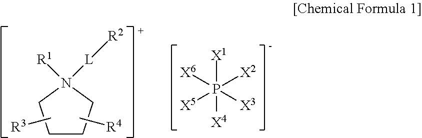
a lithium salt; and
an organic solvent:
wherein,
R¹ is hydrogen, a substituted or unsubstituted C₁ to C₃₀ alkyl group, a substituted or unsubstituted C₃ to C₃₀ cycloalkyl group, a substituted or unsubstituted C₆ to C₃₀ aryl group, a substituted or unsubstituted C₁ to C₂₀ heteroalkyl group, a substituted or unsubstituted C₂ to C₃₀ heterocycloalkyl group, a substituted or unsubstituted C₂ to C₃₀ heteroaryl group, or a combination thereof,
R² is a substituted or unsubstituted C₁ to C₃₀ alkoxy group,
R³ and R⁴ are each independently hydrogen, a substituted or unsubstituted C₁ to C₃₀ alkyl group, a substituted or unsubstituted C₃ to C₃₀ cycloalkyl group, a substituted or unsubstituted C₆ to C₃₀ aryl group, a substituted or unsubstituted C₁ to C₂₀ heteroalkyl group, a substituted or unsubstituted C₂ to C₃₀ heterocycloalkyl group, a substituted or unsubstituted C₂ to C₃₀ heteroaryl group, or a combination thereof,
L is a single bond or a substituted or unsubstituted C₁ to C₂₀ alkylene group,
X¹ to X⁶ are each independently halogen, a C₁ to C₂₀ alkyl group substituted with at least one halogen, a C₁ to C₂₀ cycloalkyl group substituted with at least one halogen, a C₁ to C₂₀ aryl group substituted with at least one halogen, or a combination thereof, and
at least two of X¹ to X⁶ are each independently a C₁ to C₂₀ alkyl group substituted with at least one halogen, a C₁ to C₂₀ cycloalkyl group substituted with at least one halogen, a C₁ to C₂₀ aryl group substituted with at least one halogen, or a combination thereof.

15. The rechargeable lithium battery of claim 14, wherein the ionic liquid is represented by the following Chemical Formula 2: 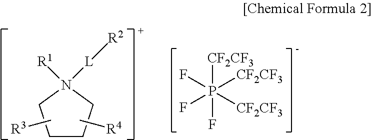
wherein,
R¹ is hydrogen, a substituted or unsubstituted C₁ to C₃₀ alkyl group, a substituted or unsubstituted C₃ to C₃₀ cycloalkyl group, a substituted or unsubstituted C₆ to C₃₀ an aryl group, a substituted or unsubstituted C₁ to C₂₀ heteroalkyl group, a substituted or unsubstituted C₂ to C₃₀ heterocycloalkyl group, a substituted or unsubstituted C₂ to C₃₀ heteroaryl group, or a combination thereof,
R² is a substituted or unsubstituted C₁ to C₃₀ alkoxy group,
R³ and R⁴ are each independently hydrogen, a substituted or unsubstituted C₁ to C₃₀ alkyl group, a substituted or unsubstituted C₃ to C₃₀ cycloalkyl group, a substituted or unsubstituted C₆ to C₃₀ an aryl group, a substituted or unsubstituted C₁ to C₂₀ heteroalkyl group, a substituted or unsubstituted C₂ to C₃₀ heterocycloalkyl group, a substituted or unsubstituted C₂ to C₃₀ heteroaryl group, or a combination thereof, and
L is a single bond or a substituted or unsubstituted C₁ to C₂₀ alkylene group.

16. The rechargeable lithium battery of claim 14, wherein the ionic liquid is represented by the following Chemical Formula 3:

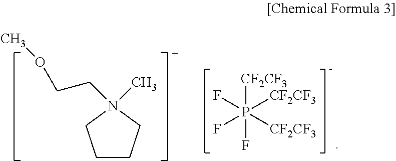

17. The rechargeable lithium battery of claim 14, wherein the ionic liquid is included in an amount of about 1 volume % to about 50 volume % based on the total amount of the electrolyte.

18. The rechargeable lithium battery of claim 14, wherein the ionic liquid is included in an amount of about 5 volume % to about 40 volume % based on the total amount of the electrolyte.

19. The rechargeable lithium battery of claim 14, wherein the electrolyte further comprises a fluorine-substituted carbonate-based compound.

20. The rechargeable lithium battery of claim 14, wherein
the rechargeable lithium battery further comprises a passivation film on a surface of the negative electrode, and
the passivation film is formed from the electrolyte.
